(19) United States
(12) Patent Application Publication
(10) Pub. No.: US 2014/0281895 A1
(43) Pub. Date: Sep. 18, 2014

(54) TECHNIQUES FOR EMBEDDING QUOTES OF CONTENT

(71) Applicants: Kah Seng Tay, Mountain View, CA (US); Kah Keng Tay, Palo Alto, CA (US); Hongping Lim, Mountain View, CA (US); Kah Hong Tay, Mountain View, CA (US)

(72) Inventors: Kah Seng Tay, Mountain View, CA (US); Kah Keng Tay, Palo Alto, CA (US); Hongping Lim, Mountain View, CA (US); Kah Hong Tay, Mountain View, CA (US)

(21) Appl. No.: 13/842,435

(22) Filed: Mar. 15, 2013

(51) Int. Cl. G06F 17/22

(52) U.S. Cl. CPC G06F 17/2247
USPC 715/234

(57) ABSTRACT

According to various embodiments, a user selection of a content portion of a content item displayed on an online webpage is received. A specific metadata portion indicating properties of the selected content portion of the online webpage is extracted, from metadata indicating properties of the webpage. The specific metadata portion is modified to generate quote metadata, based on one or more quote format rules. A preview pane of a quote content item generated based on the quote metadata is displayed, the quote content item corresponding to the selected content portion reformatted in accordance with a quote format.

### TECHNICAL FIELD

The present application relates generally to data processing techniques and, in one specific example, to techniques for embedding quotes of content.

### BACKGROUND

Many network-based applications and services that are currently in use or in development (including network-based question-and-answer applications and services) have a social aspect. For example, users of these applications are encouraged to establish connections with other users, or follow other users, for the purpose of forming virtual communities or forums via which the users can interact with one another and exchange information. Similarly, users of these applications may be encouraged to follow certain content sources, or subscribe to receive information relating to certain topics, answers to certain questions, and so forth. Many of these network-based applications and services rely partially, and in some cases almost entirely, on user-generated content—that is, content generated by the end-users of the particular application or service. The value of such applications and services to the users, and thus the success of any organization providing such applications and services, is heavily dependent upon the ability to attract and retain users who are willing to participate, for example, by consuming content, and/or interacting with other users by generating desirable, quality content that is to be shared with others.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 is a flowchart illustrating an example method, according to various embodiments.

FIG. 4 illustrates an exemplary portion of a webpage including an answer content item, according to various embodiments.

FIG. 5 illustrates an exemplary portion of a user interface window including a preview pane, according to various embodiments.

FIG. 6 illustrates an exemplary portion of a webpage including an embedded content item, according to various embodiments.

FIG. 7 illustrates an exemplary portion of an answer content item, according to various embodiments.

FIG. 8 illustrates an exemplary portion of a user interface displaying an answer content item, according to various embodiments.

FIG. 9 illustrates an exemplary portion of a user interface displaying an answer content item, according to various embodiments.

FIG. 10 illustrates an exemplary portion of a user interface displaying a preview pane, according to various embodiments.

FIG. 11 is a flowchart illustrating an example method, according to various embodiments.

FIG. 12 is a flowchart illustrating an example method, according to various embodiments.

FIG. 13 illustrates an exemplary portion of a user interface displaying a preview pane, according to various embodiments.

FIG. 14 illustrates an exemplary portion of a user interface displaying a preview pane, according to various embodiments.

FIG. 15 is a flowchart illustrating an example method, according to various embodiments.

FIG. 16 illustrates an exemplary portion of a user interface displaying trackback information, according to various embodiments.

FIG. 17 is a flowchart illustrating an example method, according to various embodiments.

FIG. 18 illustrates an exemplary portion of a user interface displaying an embedded content item, according to various embodiments.

FIG. 19 is a flowchart illustrating an example method, according to various embodiments.

FIG. 20 illustrates an exemplary portion of a user interface displaying a notification, according to various embodiments.

FIG. 21 is a flowchart illustrating an example method, according to various embodiments.

FIG. 22 illustrates an exemplary portion of a user interface displaying a quote summary page, according to various embodiments.

FIG. 23A illustrates an exemplary portion of a user interface displaying a notification, according to various embodiments.

FIG. 23B illustrates an exemplary portion of a user interface displaying a notification, according to various embodiments.

FIG. 24 illustrates an exemplary portion of a webpage displaying an answer content item, according to various embodiments.

FIG. 25 is a flowchart illustrating an example method, according to various embodiments.

FIG. 26 illustrates an exemplary portion of a user interface displaying a quote summary page, according to various embodiments.

FIG. 27 illustrates an exemplary portion of a user interface displaying a notification, according to various embodiments.

FIG. 28 is a flowchart illustrating an example method, according to various embodiments.

FIG. 29 illustrates an exemplary portion of a user interface displaying a webpage including an answer content item, according to various embodiments.

FIG. 30A illustrates an example of quote metadata, according to various embodiments.

FIG. 30B illustrates an example of quote metadata, according to various embodiments.

FIG. 30C illustrates an example of crop quote metadata, according to various embodiments.

FIG. 31 is a diagrammatic representation of a machine in the example form of a computer system within which a set of instructions, for causing the machine to perform any one or more of the methodologies discussed herein, may be executed.

### DETAILED DESCRIPTION

Example methods and systems for embedding quotes of content are described. In the following description, for purposes of explanation, numerous specific details are set forth in order to provide a thorough understanding of example embodiments. It will be evident, however, to one skilled in the art that the present invention may be practiced without these specific details.

According to various embodiments, a quote embedding system enables a user to quote portions of content items displayed in an online webpage, and then embed those quoted content portions in another webpage. Consistent with some embodiments, a content item may correspond to a question content item or and an answer content item posted on a question and answer service such as Quora.com, which is owned and operated by Quora, Inc. of Mountain View, Calif.

FIG. 1 is block diagram illustrating some of the functional modules and system components used in implementing a question-and-answer service 10 having a quote embedding system 200 for embedding quotes of content in accordance with any of the aforementioned techniques and consistent with various embodiments of the invention. As illustrated in FIG. 1, a question-and-answer service 10 is implemented as a web-based application having application logic 14 residing at one or more processor-based computer servers. At least some of the servers include a web server component or module 16 for serving data (e.g., documents or web pages) to a conventional web browser application 18 residing and executing at a client computer 20. In addition, or as an alternative, the web server module 16 may utilize one or more web-based protocols to serve content to non-web browser clients, such as a web-based mobile application residing and executing on a mobile computing device, a set-top box, a television, or some other computing device.

As is understood by skilled artisans in the relevant computer and Internet-related arts, each module or logic component shown in FIG. 1 represents a set of executable software instructions and the corresponding hardware (e.g., memory and processor(s)) for executing the instructions. To avoid obscuring the inventive subject matter with unnecessary detail, various functional modules and/or logic components that are not germane to conveying an understanding of the inventive subject matter have been omitted from FIG. 1. However, a skilled artisan will readily recognize that various additional functional modules and logic components may be used with a network- or web-based application, such as that illustrated in FIG. 1, to facilitate additional functionality that is not specifically described herein. Furthermore, the various functional modules and logic components depicted in FIG. 1 may reside on a single server computer, or may be distributed across several server computers in various arrangements.

As illustrated in FIG. 1, the client computer 20 executes a web browser application 18 to access the web-based question-and-answer application or service over a network. In various alternative embodiments, the client computer 20 may be a mobile computing device, to include: a laptop, mobile phone, e-book reader, or tablet computer. As such, with some embodiments, the question-and-answer application or service may have an interface that is customized for display in a browser, or mobile application, of a mobile device. Furthermore, with some embodiments, the client-based application may not be browser-based, but instead may be customized to suit the particular operating system of the device on which it is executing. For instance, a customized application may utilize one or more application programming interfaces (APIs) that are unique to the particular device and operating system on which the customized application resides and executes.

As shown in FIG. 1, the question-and-answer service 10 includes three separate content delivery or distribution channels 22 by which content may be communicated to users. For purposes of the present disclosure, a channel is a content delivery or distribution mechanism by which content can be communicated and presented to a user. A content distribution channel may leverage an underlying communication mechanism, such as a web server module 16, an email or messaging platform, a short messaging service (SMS), a micro-blogging service, a telephone-based service, and so forth. In the particular embodiment of FIG. 1, three separate content distribution channels 22 are shown, including a content feed 24, notifications 26 and email or messaging 28. Of course, with other embodiments, different content distributions channels may also be used.

The question-and-answer application logic 14 shown in FIG. 1 includes a variety of application modules (not shown) that provide some of the core functionality of the application, to include a content posting module, a messaging and notifications module, and an ask-to-answer module. In general, the content posting module enables users to post questions, answers and comments, as well as other content-related items of information. The messaging and notifications module operates in conjunction with the content posting module to facilitate the generation and communication of messages and notifications, which are communicated to one or more users via one of the content distribution channels 22. Accordingly, when a first user posts an answer to a second user's question via the content posting module, the messaging and notifications module will cause a message or notification to be communicated to the second user, informing the second user of the newly posted answer to the question. The ask-to-answer module analyzes a variety of information to suggest to a user the names of other users who, for various reasons, may be persons to whom a question should be directed. Of course, the application logic 14 may include a number of other modules and logic components that perform a variety of other tasks and functions beyond the immediate scope of the present inventive subject matter. In particular, the inventive concepts described herein might be implemented with a question-and-answer application or service consistent with any one or more of the features and functionality described in related U.S. patent application Ser. No. 12/795,482, entitled, “Methods and Systems for Merging Topics Assigned to Content Items in an Online Community,” filed Jun. 7, 2010; U.S. patent application Ser. No. 12/983,056, entitled, “Methods and Systems for Soliciting an Answer to a Question,” filed Dec. 31, 2010; U.S. patent application Ser. No. 12/983,062, entitled, “A Multi-Functional Navigation Bar,” filed on Dec. 31, 2010; and, U.S. patent application Ser. No. 13/766,417, entitled, “Techniques For Facilitating The Promotion Of Organic Content,” filed on Feb. 13, 2013. However, to avoid obscuring the inventive subject matter with unnecessary detail, various functional modules and logic components have not been included in FIG. 1.

The question-and-answer service 10 may be connected to a database management server 32 and/or various databases 34 managed by the database management server 32. A variety of data may be stored in various databases 34. For example, as shown in FIG. 1, databases or database tables may exist for storing user profile data 38. Generally, user profile data 38 includes personal information about each user, such as their name, email address, telephone number, place of employment, educational background, and/or any other type of personal information that might be commonly found on a resume or curriculum vitae. With some embodiments, the user profile data 38 may additionally include location information indicating the geographical location of a residence or work place of a user, information indicating a user's experience (e.g., work, study, accomplishments, awards received, etc.), and/or information indicating one or more topics on which a user has expertise.

In addition to user profile data 38, social graph data 40 may be stored in a database 34. The social graph data 40 includes information about the various relationships that exist between users of the service, and the content (e.g., questions, answers, comments, blog posts, etc.) that each user has subscribed to, or follows. For example, with some embodiments, users can follow another user—a type of unilateral relationship—and then be informed about information posted to the service by the user that is being followed. In some instances, two users may follow one another—a bilateral relationship, sometimes referred to as a direct connection. Moreover, any user-generated content, to include any of the various content items that might be promoted and presented in a content feed are stored in a database 42. The user-generated content 42 stored in the database tables include, for example, the text of questions, answers, comments, and so forth. Metadata database 36 may store various types of metadata or programming code, including metadata, quote metadata or crop quote metadata, consistent with various embodiments described herein.

In the context of the present disclosure, a channel is a content delivery and presentation mechanism by which content, including system-generated and/or user-generated content, can be communicated and/or presented to users. Various social media applications utilize a variety of different types of content delivery/distribution channels to present content to users. For instance, one particular channel is referred to herein as a content feed, but may also be commonly referred to and known by others as an activity stream, content stream, status update stream, news feed, or simply a data feed.

Using a content posting module, a user can post or publish some content (e.g., a blog post, a message, a picture, a question, an answer, etc.) to the content feeds of other users. Once posted, the content will appear in the personalized content feeds of any other users who may be connected to, or following, the particular user, or any users who are following a topic to which the posted or published content is related. For example, in the specific case of a question-and-answer service, a user may follow a question, such that, when an answer to the question is posted or published, the answer will automatically be presented in the content feed of the user who is following the question.

Another example of a content delivery/distribution channel is email or messaging where each user has an inbox and is provided with the ability to send and receive emails/messages. With some embodiments, email may provide both a mechanism by which users can communicate with one another, and by which application- or system-generated content can be communicated to users. Furthermore, the email or messaging platform may be web-based, or may use any of a variety of conventional email or messaging protocols to allow access by remote client applications. In yet another example, an application or service may provide a system of notifications. A notification channel may, for example, push certain system-generated content to users. For instance, a notification may be generated upon detecting certain conditions or events. When a user provides a comment regarding a content item, indicates that he or she likes a particular content item, or votes up or down a particular content item, a notification may be generated and communicated to the user who authored the particular content item. Similarly, in the particular context of a question-and-answer service, a user may receive a notification, for example, when another user posts an answer to a question that the user is following. A notification channel may be configured to leverage one or more underlying communication mechanisms. For example, notifications may be communicated via email, SMS, a mobile application, or any other applicable means.

Many of the examples and illustrations provided herein describe or present the inventive subject matter in the particular context of a network- or web-based, question-and-answer application or service. However, skilled artisans will immediately recognize a vast number of other contexts, including other network-based applications and services, to which the inventive concepts are applicable. In particular, the inventive concepts described herein will find application in a wide-variety of network- or web-based services, particularly those that host and encourage user-generated content and/or implement or leverage a social media platform enabling users to interact with and exchange information via one or more content distribution channels, including a content feed or stream, email or messaging platform and system of notifications. Some of the specific types of network-based applications or services to which the inventive concepts are applicable include, but are not limited to, email applications, social network services including business and professional network services, music and video services, photograph sharing applications and services, blog hosting services, and many others. Similarly, the inventive concepts described herein are applicable not only to web-based applications and services accessed via a web browser application, but also mobile applications as well as more traditional desktop client applications.

Turning now to FIG. 2, a quote embedding system 200 (which may correspond to the quote embedding system 200 illustrated in FIG. 1) includes a metadata management module 202, a preview generation module 204, and a database 206. The modules of the quote embedding system 200 may be implemented on a single device such as a quote embedding device, or on separate devices interconnected via a network. The aforementioned quote embedding device may correspond to, for example, a client machine (e.g., the client computer 20 illustrated in FIG. 1) or application server (e.g., one of the processor-based servers implementing the question-and-answer service 10 illustrated in FIG. 1).

FIG. 3 is a flowchart illustrating an example method 300, according to various embodiments. The method 300 may be performed at least in part by, for example, the quote embedding system 200 illustrated in FIG. 2. In 301, the metadata management module 202 receives a user selection of a content portion of a content item displayed on an online webpage. In 302, the metadata management module 202 extracts, from metadata associated with (e.g., indicating properties of) the webpage, a specific metadata portion associated with (e.g., indicating properties of) the selected content portion of the online webpage. In 303, the metadata management module 202 modifies the specific metadata portion (that was extracted in 302) to generate quote metadata. The quote metadata may be generated based on one or more quote format rules. In 304, the preview generation module 204 displays a preview pane of a quote content item generated based on the quote metadata, the quote content item corresponding to the selected content portion (that was selected in 301) reformatted in accordance with a quote format. Each of the aforementioned operations 301-304, and each of the aforementioned modules of the quote embedding system 200, will now be described in greater detail.

Referring back to FIG. 3, in 301, the metadata management module 202 receives a user selection of a content portion of a content item displayed on an online webpage. Consistent with some embodiments, an online webpage may include multiple content items. For example, a content item may correspond to a question content item and/or and an answer content item posted on a question page associated with a question-and-answer service, such as the question-and-answer service 10 illustrated in FIG. 1. An example of a question-and-answer service, such as the question-and-answer service 10 illustrated in FIG. 1, is Quora.com, which is owned and operated by Quora, Inc. of Mountain View, Calif. FIG. 4 illustrates an example of an online webpage manifested in the form of a question page 400, which includes a question content item 401 and an answer content item 402 posted by a user before hundred and three. As illustrated in FIG. 4, the answer content item 402 may include both rich text and rich media content (e.g., pictures, images, animations videos, slideshows, etc.), and the question page 400 displays an embed button 404 associated with the answer content item 402. Accordingly, in 301, the metadata management module 202 may receive a user selection of an entire portion of the answer content item 402, upon detecting that the user has selected the embed button 404 associated with the answer content item 402.

In 302 in FIG. 3, the metadata management module 202 extracts, from metadata associated with the webpage, a specific metadata portion associated with the selected content portion of the online webpage that was selected in 301. The metadata associated with the webpage may correspond to any data that describes the content, structure, presentation, etc. of the question page 400. For example, according to an embodiment, the aforementioned metadata may correspond to HTML programming code or XML programming code that describes content, structure, presentation, etc. of the question page 400. Thus, in 302, the metadata management module 202 may extract, from the metadata associated with an entire online webpage (e.g., metadata associated with question page 400), a portion of the metadata associated with a particular content item of the online webpage that was selected by the user 403. In the example of FIG. 4, since the user selected the embed button 404 associated with the answer content item 402, the metadata management module 202 will extract, from the metadata associated with the online webpage 400, a specific portion of the metadata that specifically describes the content included in the answer content item 402.

In 303 in FIG. 3, the metadata management module 202 modifies the specific metadata portion that was extracted in 302 to generate quote metadata, based on one or more quote format rules. For example, as illustrated in FIG. 4, the answer content item 402 includes various elements, such as an author listing 403 (“Kah Hong Tay, Born and bred in Singapore”), the actual content of the answer 402, and various links 405 (e.g., “Comment”, “Share”, etc.). Thus, the aforementioned quote format rules may indicate various operations are to be performed on the metadata associated with the answer content item 402. For example, the quote format rules may indicate that the various links 405 should be removed, that the author listing 403 should be displayed after the actual content of the answer content item 402, that a question associated with the content item (e.g., question 401) should be displayed after the author listing 403, that one or more quotation marks of a certain size and format should be placed in various positions with respect to the actual content 402, and so on. Thus, based on these quote format rules, the metadata management module 202 will modify the specific metadata of the answer content item 402 in order to generate modified metadata, also referred to as quote metadata herein. An example of quote metadata 3000 generated based on the extracted metadata corresponding to the answer content item 402 is illustrated in FIG. 30A. As described in more detail below, the quote metadata 3000 corresponds to a quote content item that represents a quote of the answer content item 402.

Referring back to the method 300 in FIG. 3, in 304, the preview generation module 204 generates a display (via a user interface in a device, such as the client device 20 illustrated in FIG. 1) of a preview pane displaying a quote content item. FIG. 5 illustrates an example of an embed user interface window 500 displayed by the preview generation module 204, where the embed user interface window 500 includes a metadata/code section 501 and the preview pane 502. The metadata/code section 501 displays the modified metadata or quote metadata that was generated in 303. (FIG. 30A illustrates exemplary quote metadata 3000 generated based on the extracted metadata corresponding to the answer content item 402, wherein the metadata/code section 501 in FIG. 5 displays the quote metadata 3000).

The preview pane 502 displays a quote content item 503 corresponding to a quote of the answer content item 402 selected by the user in 301. In particular, the quote content item 503 is generated based on the quote metadata that was generated in 303 (and which is displayed in the metadata/code section 501). In other words, the quote content item 503 corresponds to the selected content portion reformatted in accordance with a quote format, where the quote format is specified by the aforementioned quote format rules. For example, the quote format rules may indicate that the various links should be removed, that the author listing 403 should be displayed after the actual content of the answer content item 402, that a question associated with the content item (e.g., question 401) should be displayed after the author listing, that one or more quotation marks of a certain size and format should be placed in various positions with respect to the actual content, and so on. Thus, the quote content item 503 represents a quote of the answer content item 402 (e.g., the answer content item 402 after it has been reformatted into the format of a quote).

According to various exemplary embodiments, the quote metadata (e.g., the quote metadata included in the code/metadata section 501 and displayed in FIG. 30A) may include one or more links to the original content being quoted and/or the original webpage hosting the content being quoted. For example, the quote metadata may include a link to the answer content item 402 illustrated in FIG. 4, or a link to the original webpage 400 hosted on the question-and-answer service 10 that displays the answer content item 402, or links to various other elements associated with the answer content item 402, such as a link to the original question 401, and a link to identification information/profile page of the author 403, and so on. Thus, the user can select the metadata/code (e.g., HTML code or XML code) included in the metadata/code section 501 and paste this code into an appropriate webpage composer application, in order to generate an online webpage that includes a quote that will appear substantially similar to the quote content item 503 illustrated in the preview pane 502. The aforementioned application may include any hardware-based and/or software-based application for generating or composing a website or web blog post. For example, most popular blog services, including Wordpress, Tumblr, Blogger, Typepad, etc. include applications that support the ability of the user to paste HTML code into a blog composer software application in order to generate a website or web blog post.

FIG. 6 illustrates an example of an online webpage 600 (e.g., a web blog post), where the quote content item 503 of FIG. 5 has been embedded into the webpage 600 as an embedded content item 601. As illustrated in FIG. 6, the embedded content item 601 appears substantially similar (if not the same as) the quote content item 503 displayed in the preview pane 502. Thus, the preview pane 502 provides the user with an accurate visual representation of what the final appearance of the quote content item 503 will be after it is embedded in another online webpage, thereby providing the user with a “what you see is what you get” preview of the embedding functionality provided by the quote embedding system 200.

According to various exemplary embodiments, the operation 301 in the method 300 (see FIG. 3) comprises receiving a user selection of an embed request user interface element (e.g., an embed request button) displayed in conjunction with the content item. By selecting such an embed request user interface element, the user is able to select a content portion corresponding to an entire portion of the associated content item. For example, referring back to FIG. 4, the user selection of the embed button 404 enables the user to select an entire portion of a particular content item (e.g., the entire portion of the answer content item 402).

According to various exemplary embodiments, the user can also select sub-portions of a particular content item for embedding. For example, FIG. 7 illustrates another example of an answer content item 700 posted on a question-and-answer service 10. As illustrated in FIG. 7, the quote embedding system 200 displays multiple embed request user interface elements (e.g., exemplary indicia or buttons 701 and 702 in the shape of open quotation marks) throughout the answer content item 700. Each of the embed request buttons 701, 702, etc., are associated with a specific sub-portion of the content item 700. Thus, by selecting a specific one of the embed request buttons, the user is able to quote sub-portions or “snippets” of the answer content item 700. For example, if the user selects one of the embed request button 701, 702, etc., the quote embedding system 200 may highlight an appropriate portion of the answer content item 700 and display an embed command the prompt stating “Quote this snippet”. For example, as illustrated in FIG. 7, the user has selected the embed request button associated with a sub portion “1. Don't sell . . . ”, resulting in the highlighting of the appropriate snippet, and the display of a command prompt “quote this snippet” 703. The user is able to select the command prompt 703 in order to submit a request to quote/embed the appropriate snippet. Thereafter, the quote embedding system 200 may display an embed user interface similar to the embed user interface 500 described above, enabling the user to embed the appropriate sub-portion or snippet. Thus, according to various exemplary embodiments, the operation in 301 in the method 300 may comprise receiving a user selection of an embed request user interface element displayed in conjunction with a sub-portion of a content item, enabling the user to select the sub-portion of the content item for embedding.

According to various exemplary embodiments, instead of selecting a pre-defined embed request user interface button displayed in a content item, the user can simply highlight whatever portion of content item they desired to quote, and the quote embedding system 200 will automatically display an embed request button allowing the user to quote the highlighted portion of the content item. Thus, the user is not limited to quoting the entire content item (e.g. the entire answer content item 402 in FIG. 4), and the user is not forced into quoting a predefined sub-portions of the content item (e.g., the snippets illustrated in the answer content item 700 in FIG. 7). Thus, according to various exemplary embodiments, the operation in 301 of the method 300 comprises receiving a cursor highlight of the specific content portion via the user interface.

For example, FIG. 8 illustrates another example of an answer content item posted on a question-and-answer service 10. As illustrated in FIG. 8, the answer content item 800 includes an embed request user interface element 801, similar to the embed request user interface element 404 described above. Moreover, FIG. 9 illustrates the answer content item 800 of FIG. 8 after the user has selected or highlighted a particular portion 901 of the answer content item 800 (e.g., via movement of a cursor based on user manipulation of a mouse or trackpad or user gestures). As illustrated in FIG. 9, if the user highlights a desired portion 901 of the answer content item 800, the preview generation module 204 automatically displays an embed request user interface element (e.g., button) 902 in association with the selected content portion 901. The embed request button 902 may function similarly to the embed request button 404 illustrated in FIG. 4. For example, after the user selects the embed request button 902, the metadata management module 202 may extract, from metadata associated with a webpage containing the answer content item 800, a specific metadata portion associated with the selected content portion 901 of the answer content item 800. Thereafter, the metadata management module 202 may modify the extracted metadata portion to generate quote metadata, based on one or more quote format rules. (An example of quote metadata 3001 generated based on the metadata for the selected content portion 901 of the answer content item 800 is illustrated in FIG. 30B). For example, the aforementioned quote format rules may indicate various operations to be performed on the metadata associated with the selected content portion 901. For example, the quote format rules may indicate that various links should be removed, that an author listing “John Clover, Quora admin and employee” should be moved after the actual content, that a question associated with the content item should be displayed after the author listing and/or after the actual content, that one or more quotation marks of a certain size and format should be placed in various positions with respect to the actual content, and so on. Thus, based on these quote format rules, the metadata management module 202 will modify the specific metadata of the selected content portion 901 in order to generate a modified metadata or quote metadata.

Thereafter, the preview generation module 204 may generate a display (via a user interface in a device, such as the client device 20 illustrated in FIG. 1) of a preview pane displaying a quote content item, similar to various embodiments described above. FIG. 10 illustrates an example of an embed user interface window 1000 displayed by the preview generation module 204, where the embed user interface window 1000 includes a metadata/code section 1001 and a preview pane 1002, consistent with various embodiments as described above. The metadata/code section 1001 displays the quote metadata generated based on the metadata for the selected content portion 901 of the answer content item 800. (FIG. 30B illustrates exemplary quote metadata 3001 generated based on the metadata for the selected content portion 901 of the answer content item 800, wherein the metadata/code section 1001 in FIG. 10 displays the quote metadata 3001). The preview pane 1002 displays a quote content item 1003 that corresponds to a quote of the selected content portion 901 of the answer content item 800 that was highlighted by the user (see FIG. 9). In other words, the quote content item 1003 corresponds to the selected content portion 901 after it has been reformatted in accordance with a quote format, where the quote format is specified by quote format rules. For example, the quote format rules may indicate that the various links should be removed, that an author listing “John Clover, Quora admin and employee” should be moved after the actual content, that a question associated with the content item should be displayed after the author listing and/or after the actual content, that one or more quotation marks of a certain size and format should be placed in various positions with respect to the actual content, and so on. Thus, the quote content item 1003 represents a quote of the selected portion 901 of the answer content item 800 after it has been reformatted into the format of a quote.

According to various exemplary embodiments, the metadata management module 202 may determine whether or not to display an embed request button (e.g., the embed request button 902 illustrated in FIG. 9), by determining whether the user selection of content portion (e.g., the selected content portion 901 illustrated in FIG. 9) actually corresponds to a user request to embed the selected content portion. In other words, the metadata management module 202 may infer whether the user selection of a content portion actually indicates a user's desire to quote and/or embed that content portion, or whether the user is highlighting that content portion for another reason, or as a result of error, etc. According to various exemplary embodiments, the metadata management module 202 may determine whether the selection of a content portion indicates a request to embed that content portion, based on whether the selected content portion lies entirely within a single content item, or extends over multiple content items. For example, if the selected content portion lies entirely within a single content item (e.g., selected content portion 901 that lies entirely within answer content item 900 illustrated in FIG. 9), then the metadata management module 202 may determine that this user selection indicates a request to embed the selected content portion. Accordingly, the metadata management module 202 may display an embed request button, such as the embed request for button 902 illustrated in FIG. 9. On the other hand, if the selected content portion extends across multiple content items (e.g., extends across multiple answers), then the metadata management module 202 may determine that this user selection does not indicate a request to embed the selected content portion. Accordingly, the metadata management module 202 may prevent the embed request button (such as the embed request button 902 illustrated in FIG. 9) from being displayed. Thus, the quote embedding system 200 is able to reduce clutter and distractions for the user, by only displaying the embed request button when the quote embedding system 200 determines that the user is likely to request that a selected content portion be embedded.

FIG. 11 is a flowchart illustrating an example method 1100, consistent with various embodiments described above. The method 1100 may be performed at least in part by, for example, the quote embedding system 200 illustrated in FIG. 2. In 1101, the metadata management module 202 determines that a selected content portion is entirely included within a content item displayed in the online webpage. For example, the metadata management module 202 may determine that the selected content portion 901 in FIG. 9 is entirely included within the answer content item 800. In 1102, the metadata management module 202 determines that the user selection indicates a request to embed the content portion. For example, the metadata management module 202 may determine that the user selection of the content portion 901 indicates a request to embed the content portion 901. In 1103, the metadata management module 202 displays an embed request user interface element in conjunction with the selected content portion. For example, the metadata management module 202 may display the embed request button 902 illustrated in FIG. 9. In 1104, the metadata management module 202 detects a user selection of the embed request user interface element. For example, the metadata management module 202 may detect a user selection of the embed request button 902 illustrated in FIG. 9.

FIG. 12 is a flowchart illustrating an example method 1200, consistent with various embodiments described above. The method 1200 may be performed at least in part by, for example, the quote embedding system 200 illustrated in FIG. 2. In 1201, the metadata management module 202 determines that a selected content portion extends across multiple content items displayed in an online webpage. In 1202, the metadata management module 202 determines that the user selection does not indicate a request to embed the selected content portion. Thereafter, the metadata management module 202 may prevent the display of an embed request user interface element.

According to various exemplary embodiments, the quote embedding system 200 permits the user to select a portion of the quote content item displayed in the preview pane (e.g., the quote content item 1003 displayed in FIG. 10), and to crop the quote content item in order to generate a cropped quote content item. For example, FIG. 13 illustrates an embed user interface 1300 similar to the embed user interface 1000 illustrated in FIG. 10, wherein the embed user interface 1300 displays the quote content item 1003. Moreover, as illustrated in FIG. 13, the user has selected or highlighted a particular portion 1301 of the quote content item 1003 (e.g., via movement of a cursor, based on user manipulation of a mouse or trackpad or user gestures). As a result, the metadata management module 202 displays a crop request user interface element (e.g., crop request button) 1302. If the user selects the crop request button 1302, then the metadata management module 202 may generate and display a revised preview pane with the cropped portion 1301 reformatted into a new quote content item. For example, FIG. 14 illustrates an example of a revised embed user interface 1400 similar to the embed user interface 1300 illustrated in FIG. 13, where the embed user interface 1400 displays a cropped quote content item 1401 based on the crop selection 1301 (see FIG. 13).

FIG. 15 is a flowchart illustrating an example method 1500, consistent with various embodiments described above. The method 1500 may be performed at least in part by, for example, the quote embedding system 200 illustrated in FIG. 2. In 1501, the metadata management module 202 receives a user selection of a crop portion of a quote content item displayed in a preview pane. For example, the metadata management module 202 may receive a user selection of the crop portion 1301 from the quote content item 1003 displayed in a preview pane in FIG. 13. In 1502, the metadata management module 202 determines that the user selection of the crop portion corresponds to a request to crop the quote content item displayed in the preview pane. For example, the metadata management module 202 may determine that the user selection 1301 is contained entirely within the preview pane in FIG. 13. In 1503, the preview generation module 204 extracts from a metadata portion, a metadata portion associated with (e.g., indicating properties of) the selected crop portion. For example, the preview generation module 204 may extract, from the metadata representing the selected content portion 901 upon which the quote content item 1003 is based (see FIG. 9), a specific metadata portion associated with (e.g., indicating properties of) the selected crop portion 1301. Alternatively, the metadata may be extracted from the quote metadata for the quote content item 1003 (see FIG. 13).

In 1504, the preview generation module 204 modifies the metadata portion (extracted in 1503) to generate crop quote metadata, based on the one or more quote format rules. For example, the quote format rules may indicate that the various links should be removed, that an author listing “John Clover, Quora admin and employee” should be moved after the actual content, that a question associated with the content item should be displayed after the author listing and/or after the actual content, that one or more quotation marks of a certain size and format should be placed in various positions with respect to the actual content, and so on. An example of crop quote metadata 3003 generated based on the metadata for the selected crop portion 1301 of the answer content item 1001 is illustrated in FIG. 30C. In 1505, the preview generation module 204 displays a preview pane of a cropped quote content item generated based on the crop quote metadata generated in 1504. For example, FIG. 14 illustrates an example of an embed user interface 1400 that includes a metadata/code section and a preview pane, similar to the embed user interface 1300 illustrated in FIG. 13. The metadata/code section displays the crop quote metadata generated based on the metadata for the selected crop portion 1301 of the quote content item 1003. (FIG. 30C illustrates exemplary crop quote metadata 3002 generated based on the metadata for the selected crop portion 1301 of the quote content item 1003, wherein the metadata/code section in FIG. 14 displays the crop quote metadata 3002). The preview pane in FIG. 14 displays a preview of the crop quote content item 1401, generated based on crop quote metadata displayed in the metadata/code section (and illustrated in FIG. 30C). In particular, the crop quote content item 1401 corresponds the selected crop portion 1301 of the quote content item 1003 (see FIG. 13), that has been reformatted in accordance with a quote format.

According to various exemplary embodiments described above, the quote format rules may specify that certain links included in a selected portion of a content item may be removed in the corresponding quote content item. For example, the quote embedding system 200 may determine that certain types of links are unnecessary for inclusion in a quote content item, and may automatically remove these links doing generation of the court metadata corresponding to the court content item. Non-limiting examples of such links many include a comment link, a share link, a suggest edit link, and so on. Moreover, according to various exemplary embodiments, the preview generation module 204 may insert, into the quote metadata for the quote content item, and new share link or comment link associated with the quoted content. For example, if the quote is embedded in a weblog, the new share link may allow a user to share the embedded quote with a reference to that weblog. As another example, if the quote is embedded in a weblog, the new comment link may allow the user to post comments in association with the web blog.

According to various exemplary embodiments, after a quote content item is embedded into a webpage (e.g., a weblog), a series of trackbacks may be displayed on the original webpage from which the content item was quoted. For example, FIG. 16 illustrates an example of a number of trackbacks 1601, 1602, etc., that may be displayed in a trackback display window 1600. The trackback display window 1600 may be displayed proximate to an answer content item, such as the answer content item 402 illustrated in FIG. 4. As illustrated in FIG. 16, each of the trackbacks indicates at least one of: a user that embedded the quote content item; at least a portion of the content that was quoted (e.g., a quote, snippet, abstract, title, thumbnail, excerpt, etc.); a reference link to the webpage (e.g., a weblog) where the quoted content is embedded; and a view counter indicating a number of the views of the embedded content via the other webpage (e.g., weblog).

According to various exemplary embodiments, the quote metadata generated by the preview generation module 204 (such as the quote metadata included in the code/metadata section 501 illustrated in FIG. 5 or each of the quote metadata portions illustrated in FIGS. 30A-30C) includes executable trackback program code including a series of instructions that may be executed by a one or more hardware or software implemented processers. In particular, quote metadata may include one or more links to various content. For example, the quote metadata may include a link to the original content item (e.g., the answer content item 402 illustrated in FIG. 4), or a link to the original webpage 400 hosted on the question-and-answer service 10 that displays the content item 402, or links to various other elements associated with the original content item 402, such as a link to the original question 401, a link to identification information/profile page of the author 403, and so on. Moreover, the trackback code includes instructions that causes data to be generated at a host of the online webpage from which content was quoted (such as the question-and-answer service 10), if the quoted content has been embedded and published in another webpage. For example, the trackback code may include instructions that cause data to be generated at (or transmitted to) the host of the online webpage from which the content was quoted (such as the question-and-answer service 10), if the embedded code has been viewed. For example, the trackback code may include instructions specifying that, if the trackback code is executed as a result of a web browser rendering the trackback code (e.g., when a user is viewing the webpage or weblog including the embedded content), then data representing this “view” is generated at or transmitted to a certain location, device, uniform resource locator (URL), and so on. Accordingly, the trackbacks displayed in association with the content item (e.g., the trackback 1601 and 1602 illustrated in FIG. 16) may include a view counter indicating the number of the views of each embedded quote.

According to various exemplary embodiments, the quote embedding system 200 may display a specific trackback (such as trackback 1601 or 1602), only if the view count associated with that trackback is greater than a predetermined threshold. Thus, the quote embedding system 200 may ensure that the number of trackbacks displayed does not become so voluminous so as to distract the user from the underlying content item. Moreover, this operates as a security mechanism that prevents displays of trackbacks in cases where a quoted content item is not fully or properly embedded in a bona fide webpage.

FIG. 17 is a flowchart illustrating an example method 1700, consistent with various embodiments described above. The method 1700 may be performed at least in part by, for example, the quote embedding system 200 illustrated in FIG. 2 (or an apparatus having similar modules, such as client machines 110 and 112 or application server 112 illustrated in FIG. 1). In 1701, the preview generation module 204 detects that a quote content item has been embedded in another online webpage. For example, the preview generation module 204 may detect data indicating that quote metadata describing the quote content item has been embedded and published in the other webpage. In 1702, the preview generation module 204 displays a trackback item on the online webpage where the content item was quoted from, in conjunction with the content item. The trackback may identify: a user that embedded the quote content item; at least a portion of the quote content item; a reference link to the other webpage whether the quote content item is embedded; and a view counter of the other webpage. Non-limiting examples of trackbacks 1601 and 1602 are illustrated in FIG. 16.

According to various exemplary embodiments, if an edit is performed on an original content item, then an update prompt indicating that the content item has been edited may be displayed on any quoted portion of that content item that has been embedded in another webpage or weblog. For example, referring back to FIG. 6, an embedded content item 601 has been embedded into a webpage 600, where the embedded content item was quoted from the answer content item 402 illustrated in FIG. 4. If the author of the answer content item 402 edits the original answer content item 402 in the webpage 400, then the quote embedding system 200 may detect this edit, and generate a display of an update prompt over the embedded content 601 in the webpage 600. FIG. 18 illustrates an example of the webpage 600 and the embedded content item 601 (similar to FIG. 6), wherein an update prompt 1801 is displayed in association with the embedded content item 601. The update prompt 1801 indicates that the original content item 402 has been edited, and includes a link 1802 to enable the user to view the original content item 402.

The quote embedding system 200 may generate the display of an update prompt, such as the update prompt 1801 illustrated in FIG. 18, in any one of the various methods. For example, according to various exemplary embodiments, the quote metadata embedded in a webpage may include one or more links to the original content being quoted and/or the original webpage hosting the content item being quoted. For example, the quote metadata may include a link to the answer content item 402 illustrated in FIG. 4, or a link to the original webpage 400 hosted on the question-and-answer service 10 that displays the content item 402, or links to various other elements associated with the original content item 402, such as a link to the original question 401, a link to identification information/profile page of the author 403, and so on. Thus, when the quote metadata representing the quoted content item is accessed at the webpage 600 via a web browser, the web browser interpreting, rendering, and/or executing this quote metadata may access the specific reference link (e.g., URL) indicated in the quote metadata. This URL may include information or instructions causing the aforementioned web browser to display the update prompt 1801 in conjunction with the embedded content item 601.

FIG. 19 is a flowchart illustrating an example method 1900, consistent with various embodiments described above. The method 1900 may be performed at least in part by, for example, the quote embedding system 200 illustrated in FIG. 2. In 1901, the metadata management module 202 detects an edit performed on the content item displayed in the online webpage. For example, the metadata management module 202 may detect a modification performed on the answer content item 402 included in the webpage 400 (see FIG. 4), where the answer content item 402 has been embedded as an embedded content item 601 into the web blog 600 (see FIG. 6). In 1902, the metadata management module 202 generates a display, in the online webpage, of an update prompt in conjunction with an unedited version of the quote content item. For example, the metadata management module 202 may generate a display, in the weblog 600, of an update prompt 1801 in connection with the unedited version of the embedded quote content item 601 (see FIG. 18). The update prompt 1801 indicates that the source content item 402 has been updated and includes a reference link 1802 to access the source content item 402.

According to various exemplary embodiments, certain types of edits or changes made in connection with an original content item (such as content item 400 illustrated in FIG. 4) may be displayed in embedded quotes of the original content item. For example, if the question 401 associated with the original answer content item 402 (see FIG. 4) is changed, then this change to the question may be reflected in the embedded content item 601 that corresponds to the quote of the original content item 402 (see FIG. 6). As another example, if the authorship 403 associated with the original answer content item 402 is changed (e.g., edits to the name, tag, signature line, picture, avatar, etc., associated with the author) then this change to the authorship may be reflected in the embedded content item 601 that corresponds to the quote of the content item 402. The metadata management module 202 may generate a display of such changes in any one of the various methods. For example, according to various exemplary embodiments, the quote metadata embedded in a webpage may include one or more links to the original content being quoted and/or the original webpage hosting the content being quoted. For example, the quote metadata may include a link to the answer content item 402 illustrated in FIG. 4, or a link to the original webpage 400 hosted on the question-and-answer service 10 that displays the content item 402, or links to various other elements associated with the original content item 402, such as a link to the original question 401, and a link to identification information/profile page of the author 403, and so on. Thus, when the question or authorship associated with the particular content item is changed, the reference links to the question and the authorship will reflect this updated information. Thus, when the quote metadata representing the quoted content item and embedded in a webpage is accessed at the webpage 600 via a web browser, the web browser interpreting, rendering, and/or executing this quote metadata may access the specific reference link (e.g., URL) indicated in the quote metadata. This URL may include information or instructions causing the aforementioned web browser to display the updated authorship and/or question information.

According to various exemplary embodiments, the quote metadata representing a quote content item embedded in a webpage may include links to allow users to post comments, up votes, down votes, etc. in association with the embedded content items. Such comments, up votes, and down votes may be reflected in the original webpage hosting the original content item that was quoted. For example, when a user selects a comments link displayed in association with an embedded content item, the question-and-answer service 10 may detect this and/or this may result in data representing the comment to be transmitted to a specific location associated with the question-and-answer service 10. The corresponding comment may then be reproduced in association with the original content item posted on the question-and-answer service 10.

According to various exemplary embodiments, if the quote embedding system 200 determines that a quote content item has been embedded in another webpage, the quote embedding system 200 may transmit a notification to an author of the content item that was quoted, in order to alert the author of the quoting of the content item. For example, FIG. 20 illustrates an example of a notification 2000 (e.g., e-mail, text message, instant message, feed, etc.) transmitted to a user John Smith, were the notification 2000 informs the user John Smith of the quoting of a particular content item. As illustrated in FIG. 20, the notification 2000 indicates: a user that embedded the quote content item; at least a portion of the content that was quoted (e.g., a quote, snippet, abstract, title, thumbnail, excerpt, etc.); a reference link to the webpage (e.g., a weblog) where the quoted content is embedded, etc.

FIG. 21 is a flowchart illustrating an example method 2100, consistent with various embodiments described above. The method 2100 may be performed at least in part by, for example, the quote embedding system 200 illustrated in FIG. 2. In 2101, the metadata management module 202 detects that a quote of a content item has been embedded in an online webpage. In 2102, the metadata management module 202 transmits a notification message to a content author of the content item. An example of such a notification message is illustrated in FIG. 20. The notification message may identify: a user that embedded the quote content item; at least a portion of the quote content item; a reference link to the second online webpage; or a view count associated with the second online webpage.

According to various exemplary embodiments, the quote embedding system 200 is configured to display a quote summary page listing all of the content of an author that has been quoted and embedded in various webpages. For example, the metadata management module 202 may aggregate quote metadata for all the quote content items representing quotes of content items that were authored by a particular user. Thereafter, the metadata management module 202 may generate the quote summary page listing each of the aforementioned quote content items. The list may include information similar to the trackbacks described in various embodiments above (see FIG. 16). For example, the quote summary page may list, for each quote content item: a user that embedded the quote content item in an online webpage; at least a portion of the quote content item; a reference link to the online webpage where the quote content item has been embedded; or a view count associated with the online webpage where the quote content item has been embedded. For example,

FIG. 22 illustrates an example of a quote summary page 2200 for a user “Kah Hong Tay”. In particular, the quote summary page 2200 identifies various quotes of content items that have been authored by the user. The display of the quoted content items may be organized based on time e.g., recent quotes 2201, quotes from this month 2202, etc.

According to various exemplary embodiments, the amount of times the content of a user has been quoted may be used to modify the profile of the user and/or modify a status value, award value, standing, or ranking assigned to the user. For example, if a particular user is a very large number of content items which have been quoted (either in their entirety or in part, either within a predetermined time period or indefinitely), then this user may be classified as, for example, a first class citizen of the question-and-answer service 10, or the user may be assigned awards, credits, increased ranking, increased status, etc. For example, FIG. 23A illustrates an example of a notification 2300 for a user that indicates that the user has an increased status or ranking on a question-and-answer service, because their content items have been quoted a large number of times.

According to various exemplary embodiments, the amount of times a particular piece of content has been quoted may be used to modify the profile of the content and/or modify a status value, award value, or ranking assigned to the particular piece of content. For example, FIG. 23B illustrates an example of a notification 2301 for a user that indicates that a content item authored by the user has been quoted a large number of times, and accordingly that content item is now a featured content item on the question-and-answer service 10.

FIG. 24 illustrates an exemplary web page 400 that is similar to the webpage 400 illustrated in FIG. 4. More specifically, the webpage 400 in FIG. 24 includes a notification 2401 indicating that a user that posted a particular content item 402 has an increased standing or ranking, because various content items they have generated have been quoted a large number of times. Moreover, the webpage 400 in FIG. 24 includes a notification 2402 indicating that this particular content item 402 is a featured answer, because this content item 402 has been quoted a large number of times.

FIG. 25 is a flowchart illustrating an example method 2500, consistent with various embodiments described above. The method 2500 may be performed at least in part by, for example, the quote embedding system 200 illustrated in FIG. 2. In 2501, the metadata management module 202 aggregates quote metadata describing one or more quote content items associated with content items authored by a particular user. In 2502, the preview generation module 204 generates a display, via the user interface in the device, of a quote summary based on the aggregated metadata. An example of a man such quote summary page is illustrated in FIG. 22. In 2503, the metadata management module 202 modifies a status value, award value, or ranking assigned to the user, based on an amount of the one or more quote content items generated based on content items authored by the user. In 2504, the metadata management module 202 modifies a status value, award value, or ranking assigned to a specific one of the content items authored by the particular user, based on an amount of times that specific content item has been quoted and/or an embedded. Various elements of method 2500 may be omitted or rearranged, as necessary.

According to various exemplary embodiments, a quote summary page may also be displayed for each user that has quoted and/or embedded a content item. That is, the quote embedding system 200 is configured to display a quote summary page listing all of the content that has been embedded by a particular user. For example, the metadata management module 202 may aggregate quote metadata that describes all the quote content items that have been embedded by a particular user. Thereafter, the metadata management module 202 may generate a quote summary page listing each of the aforementioned quoted content items. The quote summary page may list, for each quote content item, a portion of the quote content item, and a reference link to the online webpage where the quote content item has been embedded. For example, FIG. 26 illustrates an example of a quote summary page 2600 that identifies various quotes that have been embedded by a particular user. The display of the quoted content items may be organized based on time, e.g., recent quotes 2601, quotes from this month 2602, etc.

According to various exemplary embodiments, the amount of times a user has quoted and/or embedded various content items may be used to modify the profile of the user and/or modify a status value, award value, standing, or ranking assigned to the user. For example, if a particular user has quoted a very large number of content items (either in their entirety or in part, either within a predetermined time period or indefinitely), then this user may be classified as, for example, a first class citizen of the question-and-answer service 10, or the user may be assigned awards, credits, increased ranking, increased status, etc. For example, FIG. 27 illustrates an example of a notification 2700 for a user that indicates that the user has an increased status or ranking on a question-and-answer service, because the user has quoted a large number of content items.

FIG. 28 is a flowchart illustrating an example method 2800, consistent with various embodiments described above. The method 2800 may be performed at least in part by, for example, the quote embedding system 200 illustrated in FIG. 2. In 2801, the metadata management module 202 aggregates quote metadata describing one or more quote content items embedded by a particular user. In 2802, the preview generation module 204 generates a display, via the user interface in the device, of a quote summary, based on the aggregated metadata. An example of a quote summary page is illustrated in FIG. 26. In 2803, the metadata management module 202 modifies a status value, award value, or ranking assigned to the user, based on an amount of quote content items embedded by the user. In 2804, the metadata management module 202 modifies a status value, award value, or ranking assigned to a specific content item embedded by the particular user, based on an amount of times that the content item has been embedded by various users. Various elements of method 2800 may be omitted or rearranged, as necessary.

According to various exemplary embodiments, the quote embedding system 200 permits an author of the content item to set reproduction controls in association with the content item, where the reproduction controls specify whether or not the content item may be reproduced, and whether or not the content item may be quoted or embedded in another webpage. For example, FIG. 29 illustrates an exemplary webpage 400 similar to the webpage 400 illustrated in FIG. 4. As illustrated in FIG. 29, a reproduction rules link 2901 is displayed in association with the answer content item 402. When the content author of the answer content item 402 selects the reproduction rules link 2901, a reproduction rules control menu 2902 is displayed allowing the author to specify that the content item 402 may be reproduced and embedded, or specify that the content item 402 may not reproduced but may be embedded, or specify that the content item 402 may not be reproduced and may not be embedded, etc.

While various embodiments of this disclosure describe content item corresponding to a question page posted on a question-and-answer service, it is understood that the techniques described in various embodiments derived are applicable to various types of content items, such as any online content including webpages or websites, or any electronic communications such as e-mails, text messages (such as its short message service (SMS) text messages or multimedia messaging service (MMS) text messages), instant messages, and so on.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 31 is a block diagram of machine in the example form of a computer system 3100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3100 includes a processor 3102 (e.g., a central processing unit (CPU), a graphics processing unit (GPU) or both), a main memory 3104 and a static memory 3106, which communicate with each other via a bus 3108. The computer system 3100 may further include a video display unit 3110 (e.g., a liquid crystal display (LCD) or a cathode ray tube (CRT)). The computer system 3100 also includes an alphanumeric input device 3112 (e.g., a keyboard or a touch-sensitive display screen), a user interface (UI) navigation device 3114 (e.g., a mouse), a disk drive unit 3116, a signal generation device 3118 (e.g., a speaker) and a network interface device 3120.

### Machine-Readable Medium

The disk drive unit 3116 includes a machine-readable medium 3122 on which is stored one or more sets of instructions and data structures (e.g., software) 3124 embodying or utilized by any one or more of the methodologies or functions described herein. The instructions 3124 may also reside, completely or at least partially, within the main memory 3104 and/or within the processor 3102 during execution thereof by the computer system 3100, the main memory 3104 and the processor 3102 also constituting machine-readable media.

While the machine-readable medium 3122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 3124 may further be transmitted or received over a communications network 3126 using a transmission medium. The instructions 3124 may be transmitted using the network interface device 3120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a user selection of a content portion of a content item displayed on an online webpage;
extracting, from metadata indicating properties of the webpage, a specific metadata portion indicating properties of the selected content portion of the online webpage;
modifying the specific metadata portion to generate quote metadata, based on one or more quote format rules; and
displaying a preview pane of a quote content item generated based on the quote metadata, the quote content item corresponding to the selected content portion reformatted in accordance with a quote format.

2. The method of claim 1, wherein the receiving comprises:
receiving a user selection of an embed request user interface element displayed in conjunction with the content item, wherein said selected content portion equals an entire portion of the content item.

3. The method of claim 1, wherein the receiving comprises:
receiving a user selection of an embed request user interface element displayed in conjunction with a sub-portion of the content item, wherein said selected content portion corresponds to said sub-portion of the content item.

4. The method of claim 1, wherein the receiving comprises:
receiving a cursor highlight of the specific content portion via the user interface.

5. The method of claim 4, wherein the receiving comprises:
determining that the selected content portion is entirely included within the content item displayed in the online webpage;
determining that the user selection indicates a request to embed the content portion;
displaying an embed request user interface element in conjunction with the selected content portion; and
detecting a user selection of the embed request user interface element.

6. The method of claim 4, further comprising:
determining that the selected content portion extends across multiple content items displayed in the online webpage; and
determining that the user selection does not correspond to a request to embed the content portion.

7. The method of claim 1, wherein the quote item does not include a comment link, a sharing link, or a voting link included in the content item.

8. The method of claim 1, further comprising:
receiving a user selection of a second content portion from the quote content item displayed in the preview pane; and
determining that the user selection of the second content portion corresponds to a request to crop the quote content item displayed in the preview pane.

9. The method of claim 8, further comprising:
extracting, from the specific metadata portion, a second metadata portion indicating properties of the second content portion;
modifying the second metadata portion to generate second quote metadata, based on the one or more quote format rules; and
displaying a preview pane of a second quote content item generated based on the second quote metadata, the second quote content item corresponding to the second content portion reformatted in accordance with the quote format.

10. The method of claim 1, further comprising:
detecting that the quote content item has been embedded in a second online webpage; and
displaying a trackback item on the online webpage in conjunction with the content item, wherein the trackback item includes at least one of:
a user that embedded the quote content item;
at least a portion of the quote content item;
a reference link to the second online webpage; and
a view counter of the second online webpage.

11. The method of claim 10, further comprising:
detecting an edit performed on the content item displayed in the online webpage; and
generating a display, in the second online webpage, of an update prompt in conjunction with an unedited version of the quote content item,
wherein the update prompt indicates that the content item has been updated and includes a reference link to access the updated content item.

12. The method of claim 1, further comprising:
detecting that the quote content item has been embedded in a second online webpage; and
transmitting a second notification message to a content author of the content item, wherein the second notification message identifies at least one of:
a user that embedded the quote content item;
at least a portion of the quote content item;
a reference link to the second online webpage; and
a view count associated with the second online webpage.

13. The method of claim 1, further comprising:
aggregating quote metadata describing one or more quote content items associated with content items authored by a particular user; and
generating a display, via the user interface in the device, of a quote summary based on the aggregated metadata.

14. The method of claim 13, wherein the quote summary lists the one or more quote content items and identifies, for each of the one or more quote content items, at least one of:
a user that embedded the quote content item in a second online webpage;
at least a portion of the quote content item;
a reference link to the second online webpage; and
a view count associated with the second online webpage.

15. The method of claim 13, further comprising:
modifying a status value, award value, or ranking assigned to the user, based on an amount of the one or more quote content items.

16. The method of claim 13, further comprising:
modifying a status value, award value, or ranking assigned to a specific one of the content items authored by the particular user, based on an amount of the one or more quote content items associated with the specific content item offered by the particular user.

17. The method of claim 1, further comprising:
aggregating quote metadata describing one or more quote content items embedded by a particular user; and
generating a display, via the user interface in the device, of a quote summary, based on the aggregated metadata.

18. The method of claim 17, further comprising:
modifying a status value, award value, or ranking assigned to the user, based on an amount of the one or more quote content items embedded by the particular user.

19. A non-transitory machine-readable storage medium having embodied thereon instructions executable by one or more machines to perform operations comprising:
receiving a user selection of a content portion of a content item displayed in an online webpage;
extracting, from metadata indicating properties of the webpage, a specific metadata portion indicating properties of the selected content portion of the online webpage;
modifying the specific metadata portion to generate quote metadata, based on one or more quote format rules; and
displaying a preview pane of a quote content item generated based on the quote metadata, the quote content item corresponding to the selected content portion reformatted in accordance with a quote format.

20. An apparatus comprising:
a metadata management module configured to:
receive a user selection of a content portion of a content item displayed in an online webpage;
extract, from metadata indicating properties of the webpage, a specific metadata portion indicating properties of the selected content portion of the online webpage;
modify the specific metadata portion to generate quote metadata, based on one or more quote format rules; and
an embedding module configured to display a preview pane of a quote content item generated based on the quote metadata, the quote content item corresponding to the selected content portion reformatted in accordance with a quote format.
